(19) United States
(12) Patent Application Publication
(10) Pub. No.: US 2006/0263567 A1
(43) Pub. Date: Nov. 23, 2006

(54) Method of producing wood structures and building element comprising such wood structures

(76) Inventor: Roy Johannes Hofste, Hengelo (NL)

Correspondence Address: JENSEN + PUNTIGAM, P.S., SUITE 1020, 2033 6TH AVE, SEATTLE, WA, 98121, US

(21) Appl. No.: 10/552,911

(22) PCT Filed: Apr. 13, 2004
(86) PCT No.: PCT/NL04/00243

§ 371 Date: Jun. 9, 2006

(30) Foreign Application Priority Data
Apr. 17, 2003 (NL) 1023205

(51) Int. Cl. B27G 1/00

(52) U.S. Cl. 428/57; 156/304.1; 156/304.5

(57) ABSTRACT

In known methods of preservative or upgrading heat treatment of wood, the starting material (2) is subjected to a selection process in order to select out wood with defects (6) (knots, cracks, resin ducts). A not inconsiderable part of the starting material is hereby not used to obtain thermally preserved wood. According to the invention the defects (6) are sawn out of the starting material, whereafter the remaining defect-free parts (14-1) are once again combined by finger jointing to form larger parts (16). The thus jointed wood structures (16) can be further assembled by lamination into even larger wood structures, the laminated wood structures (18). These can be applied particularly well as exterior cladding or as window or door frame in the building industry.

The invention relates to a method for manufacturing wood structures, wherein the starting material formed by a basic wood type is subjected to a preservative or upgrading heat treatment.

Such methods are generally known for preserving wood. Processes have for instance been described which are known under the trade name ThermoWood®. Under the influence of the general desire in society to reduce the use of tropical hardwood, especially in the building industry (partly due to the deteriorating quality of tropical hardwood), such thermal preservation processes have been developed which, by subjecting a less durable type of wood (the basic wood type) thereto, produce a wood type with a durability comparable to that of tropical hardwood.

Use is made in these known thermal preservation processes of a basic wood type which has as few defects as possible, which is therefore as free as possible of faults. In this context faults or defects are understood to mean any deviation which adversely affects the strength of wood, such as knots, cracks, resin ducts and the like.

In these known processes a selection is therefore carried out prior to the thermal treatment in order to obtain as much fault-free wood as possible as starting material. Due to this selection process, a not inconsiderable part of the starting material is not applied for thermal preservation. Even raw materials considered beforehand to be suitable for less critical applications, for instance as fence planks, can still have so many defects after the thermal modification that they cannot then be utilized for the intended application.

The invention has for its object to use a considerably larger fraction of the starting material to obtain a preserved end product. For this purpose undesired parts are removed from the starting material, which can be carried out prior to the heat treatment or thereafter, so as to obtain semi-products. The thus obtained semi-products are then combined into a jointed wood structure by finger jointing with the use of glue. Finger jointing is a per se known manner of making wood joints. The effect of these steps is that pieces of starting material, which would have been rejected in the selection process for the known heat treatments because they contain too many defects, in this method according to the invention nevertheless result in an end product which is suitable for the eventual application, wherein a dimension suitable for the final application is obtained by finger jointing.

The jointed wood structures are then combined into a laminated wood structure by means of lamination. Lamination is a per se known method of assembling larger wood structures from relatively small parts. In this manner a wood structure is obtained which can easily have much larger dimensions than the products obtained by means of finger jointing alone. By fitting the constituent parts together in the correct manner, an end product can moreover be obtained with more isotropic properties than purely natural wood. This is the case both for the products obtained by finger jointing alone and for the products obtained by the combination of finger jointing and laminating. Application of the combination of finger jointing and laminating provides a number of additional advantages. Compared to both thermally preserved wood and solid wood, such structures have a much greater strength, are less susceptible to cracking, are more form-retaining, thus less sensitive to stresses naturally occurring in wood, and are more readily suitable for woodworking processes such as planing and profiling.

An additional advantage of the method according to the invention is that after application of the known modification process there is a large amount of reject material as a result of the high quality requirements for the intended application. At the moment, this reject material is further processed as waste, but can also serve very well as raw material for the method according to the invention. The problem of waste can thus be reduced. The use of rejected thermally modified wood also has a favourable effect on the cost price of the end product of the method according to the invention.

According to an advantageous embodiment of the method according to the invention, the basic wood type is formed by coniferous wood. In the known method of preservative heat treatment use is preferably not made of coniferous wood, since this type of wood already has a relatively large number of defects before the heat treatment and many defects are also revealed after the heat treatment, so that much wood must be rejected as starting material, or must still be rejected after the heat treatment. With use of the invention these drawbacks are of less importance since, after forming semi-products by removing undesired parts, larger wood structures can still be obtained by finger jointing and optionally lamination of the semi-products.

In another advantageous embodiment of the method according to the invention, the glue is formed by polyvinyl acetate glue in combination with a hardener, or by a thermosetting synthetic resin glue. Polyvinyl acetate glue in combination with a hardener is particularly suitable for applications in which the resulting wood structure is not exposed to heavy loads, so-called non-bearing applications. Thermosetting synthetic resin glue is particularly suitable for applications where the resulting wood structure must be suitable for bearing applications.

The wood structures obtained by application of the method according to the invention are very suitable for building applications (in particular exterior applications) and herein particularly for construction of fascias, doors, door or window frames. These building elements are generally exposed to adverse weather influences, whereby the stated advantages of the invention are clearly manifested.

The invention will be further described on the basis of the Figures, wherein like reference numerals designate corresponding elements; herein:

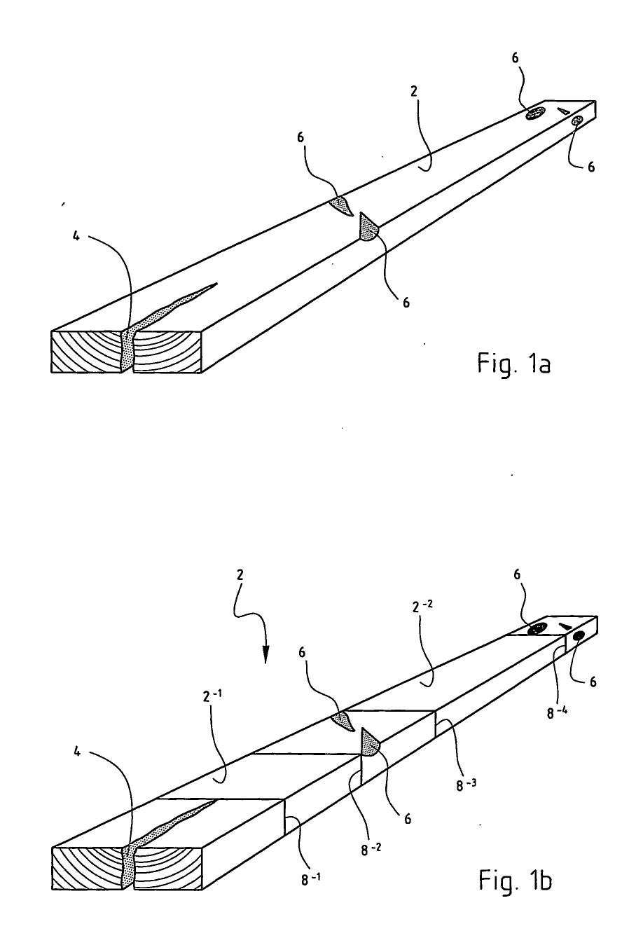

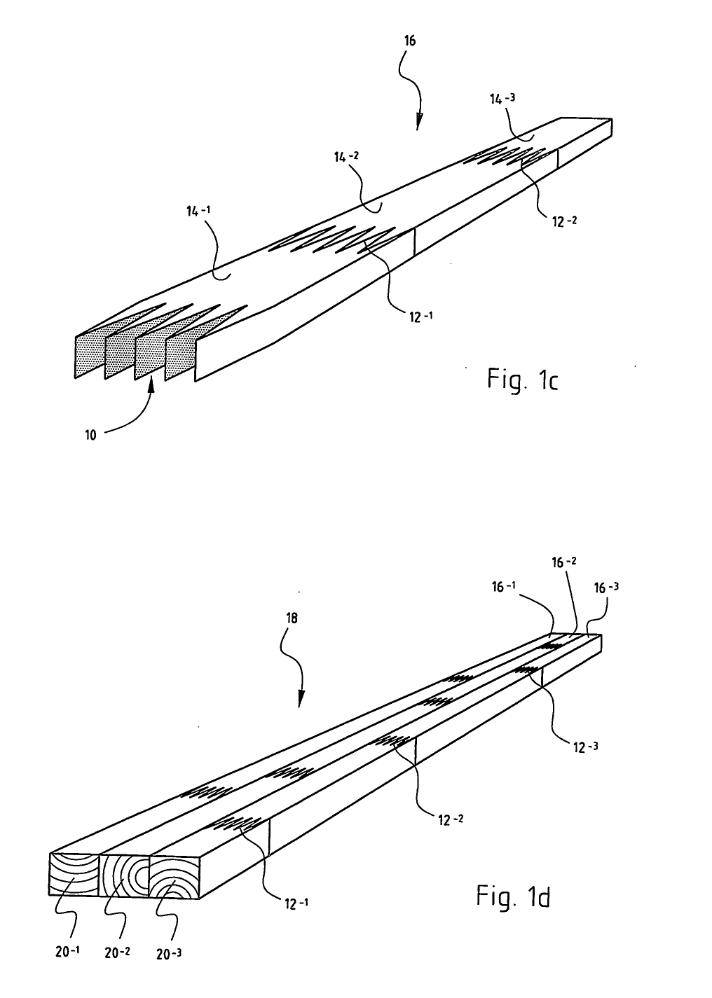

FIGS. 1a-1d show wooden parts which are subjected to the method according to the invention, at different stages of treatment;

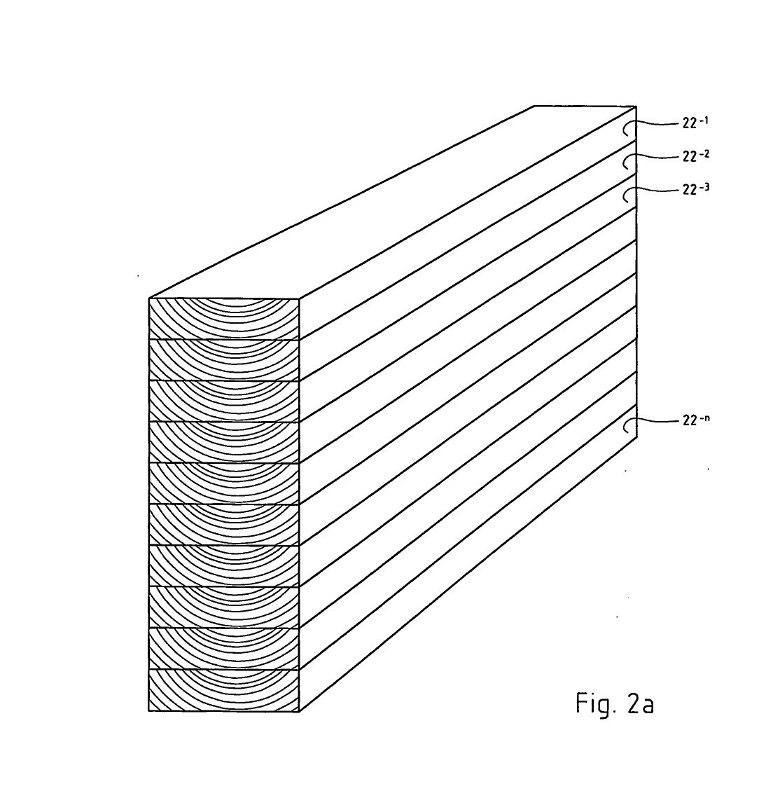

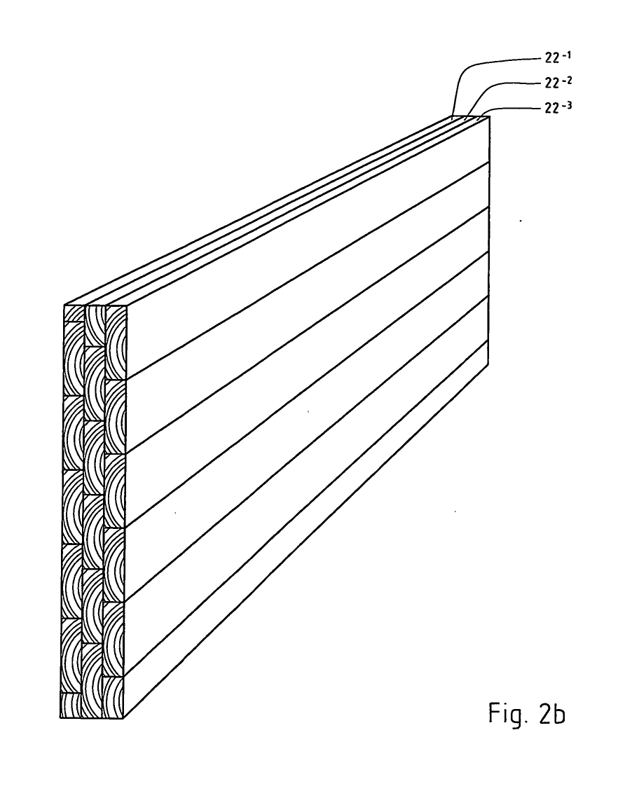

FIGS. 2a and 2b show illustrations of two different forms of lamination of wooden parts.

FIGS. 1a-1d show wooden parts which are subjected to the method according to the invention, at different stages of treatment. Use is made here of starting material in which diverse defects detrimental to the final application, such as knots, cracks and/or resin ducts, may still occur. A basic wood type forming the starting material can for instance be coniferous wood. The invention is not however limited to use with coniferous wood. Use can also be made as alternative of poplar wood or other wood type which is attractive from a price viewpoint and which, after the treatments have been performed, could compete with for instance tropical hardwood on the basis of quality and price.

FIG. 1a shows a beam 2 in which there are undesired parts such as an end split 4 and a knot 6. These undesired parts (defects) 4 and 6 can be removed from the beam before it is subjected to the upgrading heat treatment, or thereafter. An advantage of removing the undesired parts after the heat treatment can in the case of determined wood types be that defects which initially cannot be detected, or not properly, are much more clearly apparent after the heat treatment. In this manner all defects are thus removed in one treatment operation. In the case of beam 2 (FIG. 1b) this removal takes place by sawing the pieces with a defect out of the beam, see saw-cuts 8-1 to 8-4. The remaining parts (semi-products 2-1, 2-2) are then provided on those outer ends which must be connected to other parts with a finger joint profile such as profile 10 (FIG. 1c, in which the semi-products with finger joint profile are designated as 14-1, 14-2, 14-3 etc.), whereafter the finger joint profiles are provided with a layer of glue suitable for finger jointing. Only one of the surfaces for glueing can herein be provided with glue, but in the case of wood subjected to a preservative heat treatment it is recommended to provide both surfaces with glue, since the cell structure of the wood can change due to the heat treatment in a manner such that the wood absorbs the glue less easily than untreated wood. A type of glue suitable for finger jointing is for instance polyvinyl acetate glue (PVAc); when high standards are required of the wood structure, this glue can be applied in combination with a hardener. Another suitable glue type is a thermosetting synthetic resin glue which can be applied in the form of a single-component glue or as two-component glue.

The glueing of the profiled parts 14-1 to 14-3 takes place in the usual manner by joining the finger profiles to each other and allowing the glue between the parts to set under a suitably chosen pressure and/or temperature. Created in this manner as jointed wood structure is a beam 16 which no longer displays the initial defects. This beam can in principle be made to any desired length by connecting together a random number of parts by finger jointing. Once beams 16 have been formed in this manner, they can be planed and laminated to form a larger whole 18 as finishing process, see FIG. 1d which shows a laminated wood structure. During lamination the relative directions of the constituent wood parts 16-1 to 16-3 can be chosen relative to each other such that form deviation or continued working of one of the parts due to the working always occurring in the wood are compensated or prevented by form deviation or continued working in one or more other parts, as indicated in FIG. 1d by the mutually different orientations of annual rings 20-1 to 20-3 in the end surfaces of parts 16-1 to 16-3.

FIGS. 2a and 2b are an illustration of two different forms of laminating wooden parts. The parts shown in FIG. 1c or 1d, which are thus obtained by finger jointing alone (FIG. 1c, reference numeral 16) or by finger jointing and lamination together (FIG. 1d, reference numeral 18), can be joined once again to form larger wood structures by means of (further) lamination. In FIG. 2a said wood structures resulting from finger jointing and/or laminating are joined together; components 22-1 to 22-n which are joined together here can be formed by a beam 16 resulting from finger jointing only, as shown in FIG. 1c, or by a laminated wood structure 18 resulting from finger jointing and subsequent lamination, as shown in FIG. 1d. These wood structures 16 or 18 can be stacked horizontally, thus with their largest surfaces connected to each other, as shown in FIG. 2a, in which case reference is made to a horizontally laminated wood structure. Wood structures 16 or 18 can be stacked vertically, thus with their narrow sides connected to each other, and the thus resulting structures are in turn mutually connected with their larger surfaces, as shown in FIG. 2b, in which case reference is made to a vertically laminated wood structure.

Finally, the invention is expressly not limited to the described and shown embodiments, but generally extends to any embodiment falling within the scope of the appended claims, as seen in the light of the foregoing description and drawings.

1. Method for manufacturing wood structures, wherein
the starting material formed by a basic wood type is subjected to a preservative heat treatment, and wherein undesired parts are removed from the starting material so as to obtain semi-products;
the semi-products are combined into a jointed wood structure by finger jointing with the use of glue; and
the jointed wood structures are combined into a laminated wood structure by lamination.

2. Method as claimed in claim 1, wherein the basic wood type is formed by coniferous wood.

3. Method as claimed in claim 1 or 2, wherein the glue is formed by polyvinyl acetate glue in combination with a hardener, or by a thermosetting synthetic resin glue.

4. Building element for a building, which building element contains a wood structure manufactured in accordance with the method as claimed in any of the foregoing claims.

5. Building element as claimed in claim 4, which building element is formed by a fascia, a door and/or a door or window frame.
